(19) United States
(12) Patent Application Publication
(10) Pub. No.: US 2008/0120539 A1
(43) Pub. Date: May 22, 2008

(54) INTERNET-BASED COMPUTER FOR MOBILE AND THIN CLIENT USERS

(76) Inventor: Kenneth Dean Stephens, Jr., Waialua, HI (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 11/940,204

(22) Filed: Nov. 14, 2007

Related U.S. Application Data
(60) Provisional application No. 60/866,428, filed on Nov. 19, 2006.
(60) Provisional application No. 60/887,315, filed on Jan. 30, 2007.

(51) Int. Cl. G06F 17/24

(52) U.S. Cl. 715/256

(57) ABSTRACT

A web-based computer platform for users of Internet-capable thin client devices is disclosed. The systems and methods bring computer feel and functionality to users of cell phones, smart phones, PDA and other small screen and thin client devices. The system further includes means for storing and converting files, games, and accessing other media presently not available to users of such devices.

### CROSS REFERENCE TO RELATED APPLICATIONS

This application claims priority to U.S. Provisional Patent Application No. 60/866,428, filed on Nov. 19, 2006, entitled “Internet-Based Computer for Mobile and Thin Client Users,” and U.S. Provisional Patent Application No. 60/887,315, filed on Jan. 30, 2007, entitled “Improved Internet-Based Computer for Mobile and Thin Client Users.” Priority to the prior applications is expressly claimed, and the disclosures of the prior applications are hereby incorporated by reference in their entirety.

### FIELD

The present disclosure relates generally to systems and methods for providing a web-based computer platform for users of Internet-capable mobile, handheld and/or portable devices.

### BACKGROUND

Many web-based applications already exist, and a goodly number of these work very well, provided that the user has a multi-feature browser and clean, broadband connection to the Internet. To cite just a few examples, both Writely™ and Zoho® Writer are decent online word processors. Writely™ and Zoho® are both in beta versions and owned by Google® and Adventnet, Inc.™, respectively. An online computer emulation also exists, called YouOS®. Although it is in even earlier alpha build at the moment, web-based offerings include a rich text editor (word processor) called YouEditor, file management system called YouFiles, among others.

Each of Writely™, Zoho® Writer and YouOS® work reasonably well provided the user has two major assets: (1) a relatively high bandwidth Internet connection; and (2) a device and browser that supports JavaScript® (Standard ECMA-262 ECMAScript, originally developed by Netscape Communications Corp), CSS (cascading style sheets) and various other elements.

(1) Relatively high bandwidth Internet connection. Tests using a dialup connection prove each of the above systems slow and cumbersome, even on standard computers current with users. Adding burden to such connections, e.g. by simultaneously downloading updates, makes pages on all three load extremely slowly, requiring a minute or more in some cases, and introduces latency unacceptable to the average user. In tests, a “burdened” 56 Kbps dialup connection added lag times of 0.25 to 0.5 seconds between user keystrokes and letters appearing on-screen in each word processor. This lag is simply intolerable to people accustomed to real-time text entry on their viewing screen.

(2) Device and browser that supports JavaScript® (Standard ECMA-262 ECMAScript, originally developed by Netscape Communications Corp), CSS (cascading style sheets) and various other elements. Each one of the above mentioned web sites utilizes the JavaScript® programming language, and everything thereon works quite well on standard PCs with Internet connection rates of 100-1000 Kbps or more. Low Internet connection bandwidth was mentioned as a serious issue in point 1 above. More serious still are limitations imposed by portable and thin client devices and their compact web browsers. In point of fact, many small systems would not run the above applications even with adequate bandwidth present. This is because they 1) cannot deal with the amounts of information needing downloading; 2) have incomplete support or no support at all for JavaScript®; or 3) have tiny displays incapable of resolving the text and graphic content of each site.

In testing Writely™, Zoho® Writer and YouOS®, not a single mobile system was able to download and resolve the information necessary to perform computing tasks on any of the three web sites, and these are among the best currently available. Other online applications run in Java® or Flash, formats even less supported by thin client devices like cell phones, smart phones and PDAs, or require entire applications to be downloaded and run on the client browser, a task that often overwhelms the devices in question.

While many web-based applications either currently exist or are in advanced states of development, the vast majority focus on serving the enterprise: commercial and institutional customers with high-speed Internet connections and deep computing resources. Therefore, a need exits for a system that can provide a web-based computer platform to the huge potential user base of people without computers.

Other systems, methods, features and advantages of the various embodiments disclosed herein will be or will become apparent to one with skill in the art upon examination of the following figures and description.

### SUMMARY

An exemplary embodiment described herein relates to the design and provision of an online personal computer (PC) for two large user groups. The first group, the “CyberPC®” group, encompasses hundreds of millions of people with Internet access through mobile and portable devices like cell phones, personal data assistants (PDAs), smart phones, game consoles, and Internet-capable devices in vehicles, among others. The second group, the “OnePlanet® PC” group, is potentially even larger, encompassing a large portion of the world's population currently without a computer. While the majority of this group probably has little hope of ever owning a physical PC, many may soon be able to access the Internet via a community computer or thin client web browser.

Despite the distinctions, the two groups have much in common, including less-than-perfect conditions of Internet access. In the CyberPC® case, connections may be low bandwidth by nature or because of heavy traffic, physical obstacles, range issues, noise or any combination of these factors. OnePlanet® PC users are apt to have very similar throughput issues, brought on by poor connections, low bandwidth dialup access, link distance, path noise and the poor telecommunications infrastructure that plagues many so-called “developing” countries and regions of the world.

Disclosed herein are means and system architecture to address Internet path and bandwidth issues while providing the basis for a satisfying online computer experience for the two large user groups mentioned above. Also disclosed herein is an Internet-based computer, including means, methods and system architecture to provide a simple, useful and universal web-based (online) computer platform for users of Internet-capable mobile, handheld and portable cell phones, smart phones, PDAs, game consoles and other small-screen devices. A comprehensive virtual online computer is described, with functions compatible with cell phones, game consoles and almost any other device capable of browsing the Internet. Although each particular embodiment or implementation of the present disclosure can vary the applications and features provided, among the system's many features are a powerful PHP Text Editor; online storage space for presentations, documents and photos; scientific calculator, calendar with day notes and dual time-zone clock; email, instant message, chat room and blog capability; games like checkers, Hangman and Solitaire; utilities for photos and scans; portals for receiving live information streams; and an online repository for electronic music, publications and music.

The registration, login, and desktop functions described herein provide a simple, useful and universal framework to bring computer feel and functionality to diverse users, devices and client operating systems. Novel approaches to text editing, communications, calendar, day book, clock and games result in an online computer experience with quick response time and a smooth, clean and effective user interface for even basic cell phones, standalone web browsers and low-end computers.

### BRIEF DESCRIPTION OF THE DRAWINGS

FIG. 1 is an exemplary top-level block diagram of an embodiment of the present disclosure.

FIG. 2 is an exemplary block diagram of the word processing options of an embodiment of the present disclosure.

FIG. 3 is an exemplary embodiment of the word processor interface of the present disclosure utilizing a local Java® applet.

FIG. 4 is an exemplary embodiment of the word processor interface of the present disclosure utilizing a JavaScript® and BBcode based editor.

FIG. 5 is an exemplary embodiment of the word processor interface of the present disclosure utilizing a PHP text editor.

FIG. 6 is an exemplary embodiment of the word processor interface of the present disclosure utilizing a plain text editor with enhancements.

FIG. 7 is an exemplary embodiment of a virtual scanner that can be used with the systems and methods of the present disclosure.

FIG. 8 is an exemplary embodiment of a My Photos application that can be used with systems and methods of the present disclosure.

FIG. 9 is a top-level block diagram of the features and functions of an exemplary text editor that can be used with the systems and methods of the present disclosure.

FIGS. 10A and 10B are exemplary screen shots of the edit screen of editor depicted in FIG. 9.

FIG. 11 is an exemplary top-level block diagram of the text entry system that can be used with embodiments of the systems and methods of the present disclosure.

FIG. 12 is an exemplary top-level block diagram of the online word processor operations that can be used with embodiments of the systems and methods of the present disclosure.

It should be noted that the figures are not drawn to scale and that elements of similar structures or functions are generally represented by like reference numerals for illustrative purposes throughout the figures. It also should be noted that the figures are only intended to facilitate the description of the preferred embodiments of the present disclosure. The figures do not illustrate every aspect of the present disclosure and do not limit the scope of the invention.

### DETAILED DESCRIPTION

The foundation technology behind an Internet-based computer for thin client devices like cell phones starts with an administrative panel able to serve simple but functional registration and login forms to such clients. Next up the chain is a file manager with the ability to archive files online and create documents on the local client device via PHP/HTML forms served from web site to local client device.

This action of transferring text input functions to the client is what makes the document creator and critical elements of the word processor upon which it is built function on the thin client devices one might expect in CyberPC® and OnePlanet® PC environments. Each is apt to employ minimal hardware, small browsers and basic operating systems while having to cope with low bandwidth Internet connections, path noise and other connection environments less than ideal.

In addition to providing a simple, useful and universal web-based (online) computer platform for users of Internet-capable mobile, handheld and portable cell phones, smart phones, PDAs, game consoles and other small-screen devices, the registration, login, document manager and word processor described herein provide a simple, useful and universal framework to bring computer feel and functionality to diverse users, devices and client operating systems in a manner supportive of the specific language and alphabet or character set of each user group. The result is an online computer experience with quick response time and a smooth, clean and effective user interface for many diverse groups, devices and operating systems.

Although CyberPC®-supporting devices are apt to have Web browsers, cache, cookie and possibly even JavaScript® ability, low-end mobile users are more likely to have little more than rudimentary Internet access via WiFi or their network provider. In fact, most low-end mobile users are unlikely to have even made use of such access due to cost constraints and/or technology limitations. To these users, Virtual SmartPhone™, another emulation of the present disclosure is addressed, effectively empowering them with “smart phone” features. The systems and methods of the present disclosure address Internet path and bandwidth issues while providing the basis for a rich and satisfying online experience for the large user groups mentioned above.

In one aspect of embodiments of the present disclosure, a simple, useful and universal web-based (online) computer platform for users of Internet-capable mobile, handheld and portable cell phones, smart phones, PDAs, game consoles, vehicular devices and other small-screen devices is disclosed.

In another aspect of embodiments of the present disclosure, a simple, useful and universal web-based (online) computer platform for users of thin client devices, computers, “web boxes,” and terminal devices, all Internet-capable in some form or manner is disclosed.

In another aspect of embodiments of the present disclosure, a system and method to bring computer feel and functionality to millions of users of cell phones, smart phones, PDAs, game consoles, vehicular devices and other small-screen devices is disclosed.

In another aspect of embodiments of the present disclosure, a system and method to bring full computer feel and functionality to millions of the world's peoples currently without computer access or ownership is disclosed.

In another aspect of embodiments of the present disclosure, a simple, useful and universal framework to bring computer feel and functionality to diverse users, devices and client operating systems, and in a manner supportive of the specific language and alphabet or character set of each user group is disclosed.

In another aspect of embodiments of the present disclosure, systems and methods to provide a satisfactory online computer experience to many and diverse groups, devices and operating systems with quick response time and a smooth, clean and effective user interface are disclosed.

In another aspect of embodiments of the present disclosure, systems and methods to provide a satisfactory online computer experience to users even under less-than-ideal conditions of Internet connectivity, including low bandwidth, path noise and other degrading factors that might be experienced in mobile, rural or so-called “third world” environments are disclosed.

In another aspect of embodiments of the present disclosure, systems and methods to provide “smart phone” capability is provided to millions of low-end cell phones, Voice Over Internet Protocol (VOIP or SKYPE®) phones, game consoles and similar devices with rudimentary Internet connection ability are disclosed.

In another aspect of embodiments of the present disclosure, systems and methods for providing online word processor functionality to thin client devices like cell phones, stand-alone web browsers, game consoles and very low-cost computers are disclosed.

In another aspect of embodiments of the present disclosure, systems and methods for providing means for plain-text devices to add certain rich text features to text and document creation even though the devices themselves cannot display HTML are disclosed.

In another aspect of embodiments of the present disclosure, systems and methods for providing means for devices to display languages with character sets other than alphabetic, such as Chinese, Hindi, Japanese and Arabic are disclosed.

In another aspect of embodiments of the present disclosure, systems and methods for providing means for a virtual on-line scanner to convert documents, graphics, symbols and other material into compatible formats for display and printing are disclosed.

In another aspect of embodiments of the present disclosure, systems and methods for providing means to downsize and otherwise convert JPG and other format photos into smaller, more efficient files compatible with the client device's display capability are disclosed.

In another aspect of embodiments of the present disclosure, systems and methods for providing means for reformatting files to fit user needs and device standards, including graphics, audio, video and audio-visual files, slide shows and podcasts are disclosed.

In another aspect of embodiments of the present disclosure, systems and methods for providing means for the online expansion and reconstruction of various compression formats are disclosed.

In another aspect of embodiments of the present disclosure, systems and methods for providing architecture and functionality which can be scaled and customized to the needs of specific clients, users and groups are disclosed.

In another aspect of embodiments of the present disclosure, systems and methods for providing a portal to streaming services, including but not limited to news, weather, sports, financial data, and specialized fare are disclosed.

In another aspect of embodiments of the present disclosure, systems and methods for providing an online repository for electronic books, periodicals and other publications are disclosed.

In another aspect of embodiments of the present disclosure, systems and methods for providing an online repository for music in various electronic formats, including but not limited to MP3, WMA and MIDI are disclosed.

In another aspect of embodiments of the present disclosure, systems and methods for providing an online repository for other media, including but not limited to video clips, movies and games are disclosed.

In another aspect of embodiments of the present disclosure, systems and methods for providing an online repository for specialized data, including but not limited to electronic business forms, coupons and electronic greeting cards are disclosed.

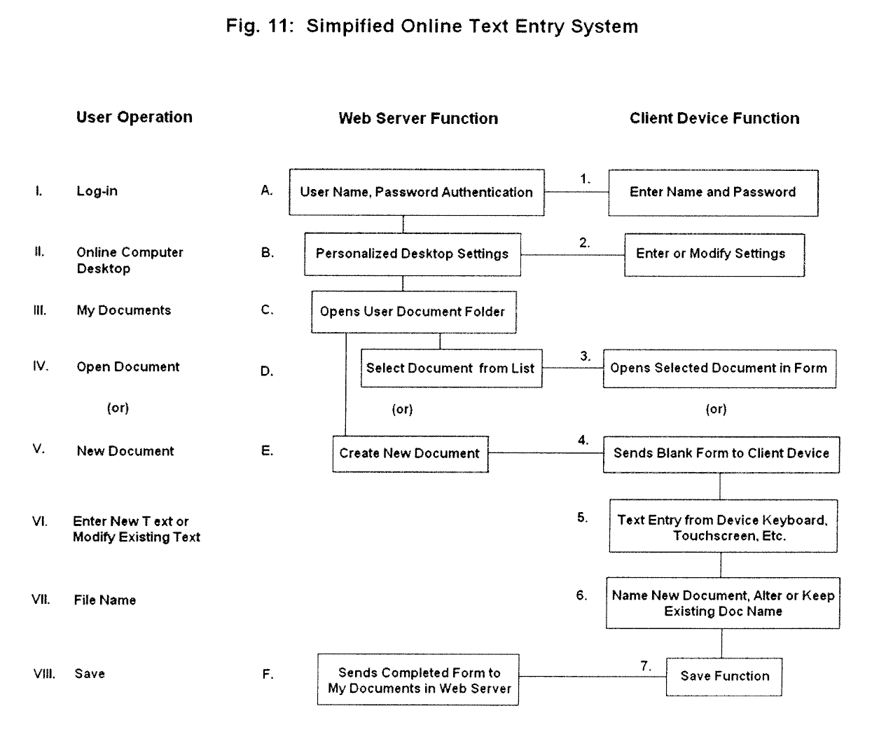

Turning to the figures, FIG. 11 shows user operations (Roman Numerals), server functions (letters) and client device functions (numbers) to chart several processes involving online text entry, which is used in preferred embodiments of the present disclosure. In the drawing, a previously-registered user logs onto the Internet-based computer web site I; entering her/his user name and password from a local keyboard, touch screen or other entry method 1, and sending the information to the online computer site A.

After log-in, the user will see her/his personalized desktop II, including wallpaper (if selected) and various icons. One icon allows users to enter or modify personalized settings, select applications, games and categories from a menu of options from their device 2 to the online server B.

Selecting “My Documents” III opens a user document folder on the server side C, and the user has the option of either IV opening an existing document from a list of those already stored in her/his online document space or V, creating a new document.

In the first option IV, the user selects a document already stored on the web server D, and 3 opens the selected document in a PHP or HTML form on the client device. In the second option V, the user chooses to open a new document, and the web server E creates a blank PHP or HTML form and sends it 4 to the client device. What is important in both instances is that the PHP/HTML form resides on the client device, allowing user input of text and other functions in real time from the client device without latency. One example of unwanted latency has been cited above: lag between keystrokes and the resulting letters appearing on the local client device screen.

This simple process is one of the major differentiators between the present disclosure and other web-based word processors like those mentioned previously. Text entry in Writely™, Zoho® Writer and YouOS® is done online on the server side, while text entry in the present disclosure is done at the client device. In consequence, low Internet connection bandwidth, path noise and intermittent connectivity do not effect the hand-eye coordination required when the user is typing or otherwise entering text and data.

Moving down the operation and process boxes, once the filled (existing document) or blank (new document) HTML or PHP form is served to the client device, text entry VI can proceed from the user keyboard, touch screen or the like 5. When this process is complete, the user VII enters, modifies or keeps a name for the file 6 from the client device, and then clicks Save VIII. This client-side function 7 sends the completed form back to My Documents in the web server F.

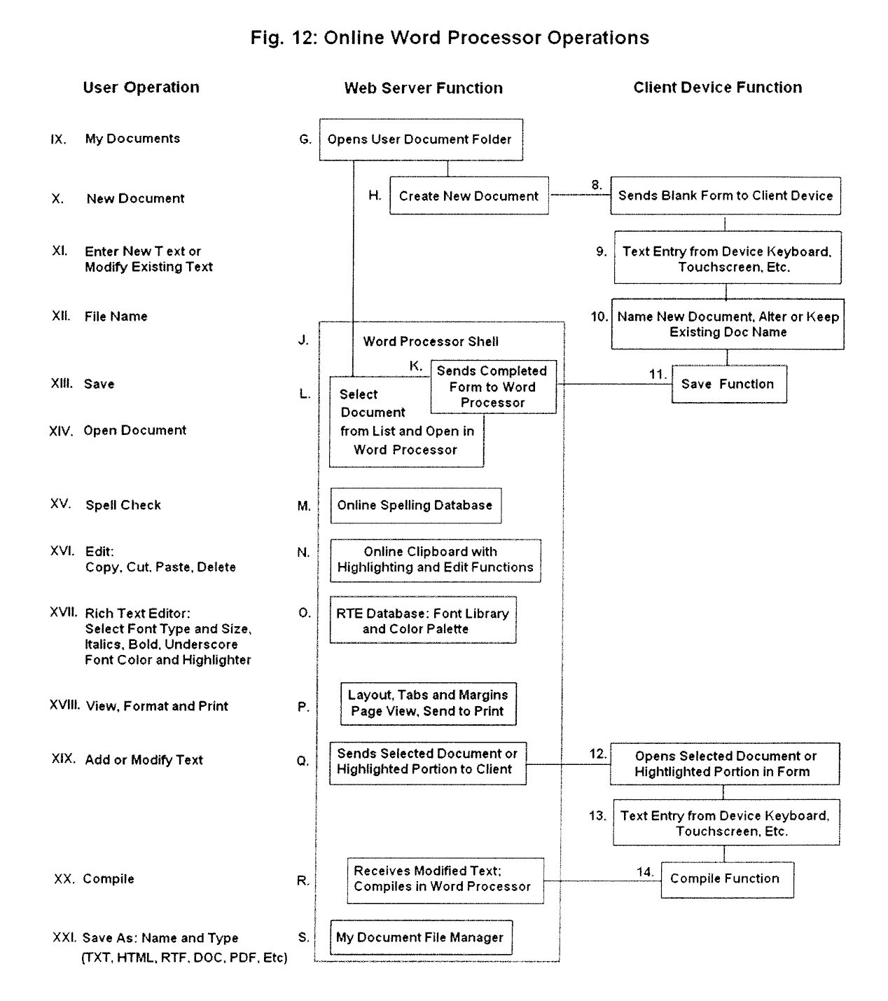

FIG. 12 expands the operations and processes in FIG. 11 to include a basic word processor shell, utilizing the same lettering and numbering convention to highlight user operations (IX-XXI), web server functions (G-S), and functions taking place on the client device, operating system and web browser (8-14).

Specifically, FIG. 12 starts with the user clicking My Documents IX, an operation G opening the user's document folder on the web server. If the user selects the New Document option X, the web server will H create a new document by 8 sending a blank PHP or HTML form to the client device. As in FIG. 11 above, this permits user XI to input text 9 in real time from the client keyboard or touch screen without lag or latency.

When the entry process is complete, the user XII enters a name for the file 10 from the client device, and then clicks Save XIII. The client-side Save function 11 sends the completed form back to the web server K where it opens in a Word Processor shell J.

The user Open Document function XIV also brings up the server-based Word Processor shell J by selecting an existing document from the user list L. In either case (new document or one selected from a list) we now have a document open in a word processor, where a number of user operations can be performed:

Word Processor Operations and Functions. Most word processor operations will take place online, aided by online databases for spell check and other dictionary functions; online clipboard for cut, copy and paste functions; and online style sheet library of fonts, colors, formats and so on. Here is a brief rundown of the word processor features listed in FIG. 12:

Open Document. This is essentially a file manager function, but one taking part online L in the word processor shell. The operation XIV displays a list of online user document files and opens the one selected by the user.

Spell Check. The user spell check operation XV compares an open document, highlighted section or word against on online dictionary database M, flagging items not in the database and suggesting corrections where possible.

Edit: Copy, Cut, Paste, Delete. These user operations, collectively labeled XVI, invoke an online clipboard N with highlighting and editing functions where these are supported by the user device. In very thin client devices, browsers and operating systems supporting little more than basic text, initial transactions between online server and client device will either detect client capabilities and default to text-only operation or give the user that option.

Rich Text: Font, Color, etc. Collectively under XVII are user options for selection of font style, size, bold, italic, underscore, color, on-page highlighting and so on. These take place in a style sheet database with online font library and color palette. The database may be a subset of CSS (cascading style sheets), with various functions applied where supported by the user device, but even in cases with less client support there are ways, for example, of indicating color, bold, italic and so forth. This allows a rich text document to be saved for printing or viewing elsewhere in full rich text.

View, Format and Print. Included in this user operation set XVIII are options to view pages in HTML, preview for printing, view with editing notations and so forth. View, Format and Print functions P take place online in the word processor shell, where layout templates, tabs and margins can also be applied and adjusted. A Print operation will send the page(s) to a printer associated with the appropriate user client device.

Add or Modify Text. This operation XIX includes an option to send the entire document, page or a selected portion (probably highlighted where that is possible) from server Q to client 12 for modification, adding or deleting text from the local text entry keyboard or touch screen 13.

There are 2 very good reasons to have an option to select a portion of a document:

1. Some small, thin client devices like PDAs and cell phones allow only minimal amounts of text, clipping the end of forms that deliver more than the allowed amount; and

2. The document to be modified may have already been enriched with colors, font changes and so forth, and sending it in complete form will make it revert back to basic text on many thin clients.

On the other hand, sending only a couple of bracketed or highlighted words around the section needing change will address the “long file” problem under the first point and minimize any negative effects on processing in the second point, rendering the resulting modified text simple to clean up.

Compile. When text has been appropriately added or modified by the user on the client device, it is compiled XX and sent from client 14 back to the online server R which receives the modified text and compiles the completed document in the word processor shell where it can be correctly formatted.

Save As. This operation XXI saves the completed document by name and type (extension in Windows terminology) in the online user document file manager S. Files types may include text (TXT), HTML (HTM), rich text (RTF), Word® document (DOC), portable document format (PDF) and others.

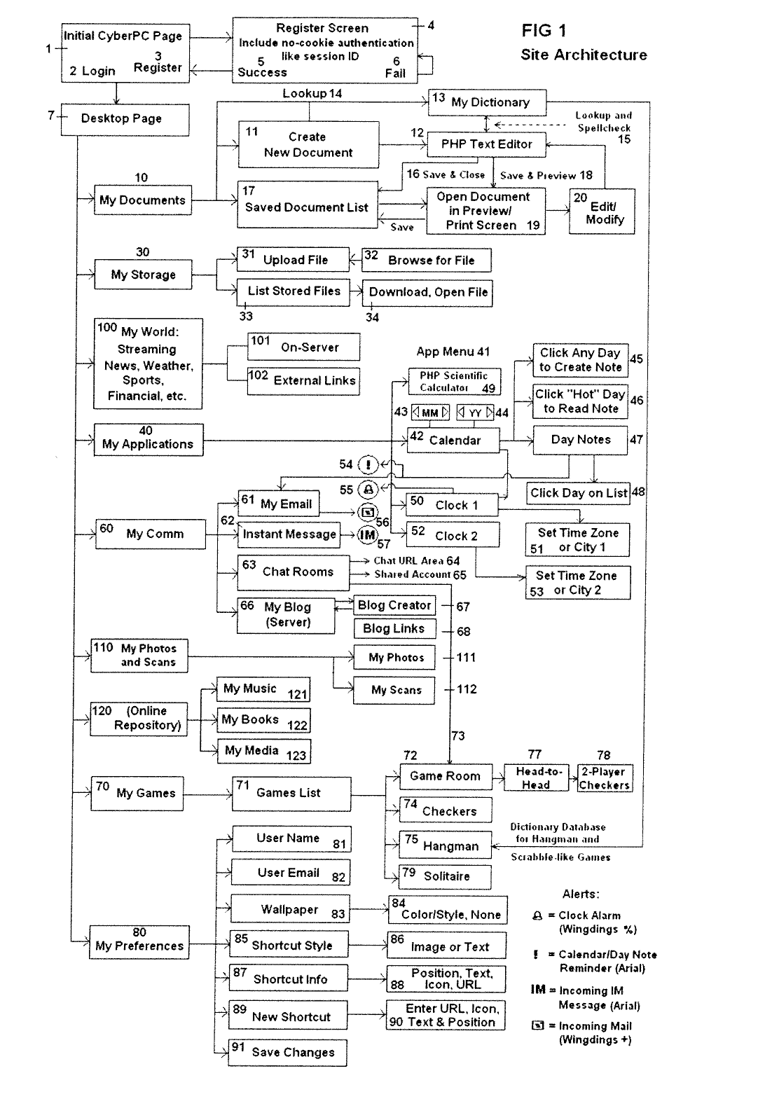

FIG. 1 maps an exemplary architecture of one embodiment of the present disclosure. The features described and implementations for the features described are provided as examples only, and the scope of the disclosure is not limited to the embodiments described herein. In the drawing, an initial page 1 preferred features little more than login and register options, without wallpaper or any indication of what might be inside. This serves the double function of looking plain and uninteresting to uninvited guests while showing up in text form on almost any Internet-capable cell phone or other device.

Clicking Register 3 brings up a register form 4 including a currently-required registration key, boxes for user name, Email address, user name and password, the latter double-entered to validate. If registration is successful 5, the user will again see the login screen 2; if registration fails 6, a blank registration screen will once again appear. For security purposes, the number of user attempts to register and/or log in can be appropriately limited during each session.

A new or previously registered user logs onto the Internet-based computer web site by entering her/his user name and password from a local keyboard, touch screen or other entry method 2. This action generates a session cookie consisting of user data and encrypted password hash which follows her/him throughout the entire CyberPC® session. An alternate session ID tracking method can be used for simple cell phones and like devices which cannot accept cookies.

After log-in, the user will see her/his personalized desktop page 7, including wallpaper (if selected) and various function bars or text, numbered 10, 30, 40, 60, 70 and 80 (other functions are described below).

Selecting My Documents 10 brings up a screen with New Document 11 and Folder options as well as access to online dictionary 14 and a list of saved documents 17 already stored in that user's online document space. Clicking New Document 11 will bring up a Text Editor screen 12. If JavaScript® is supported by the client device, editor 12 can be a rich text editor including a number of features to be described in detail below; if JavaScript® is not supported, that user will see a simple text entry form.

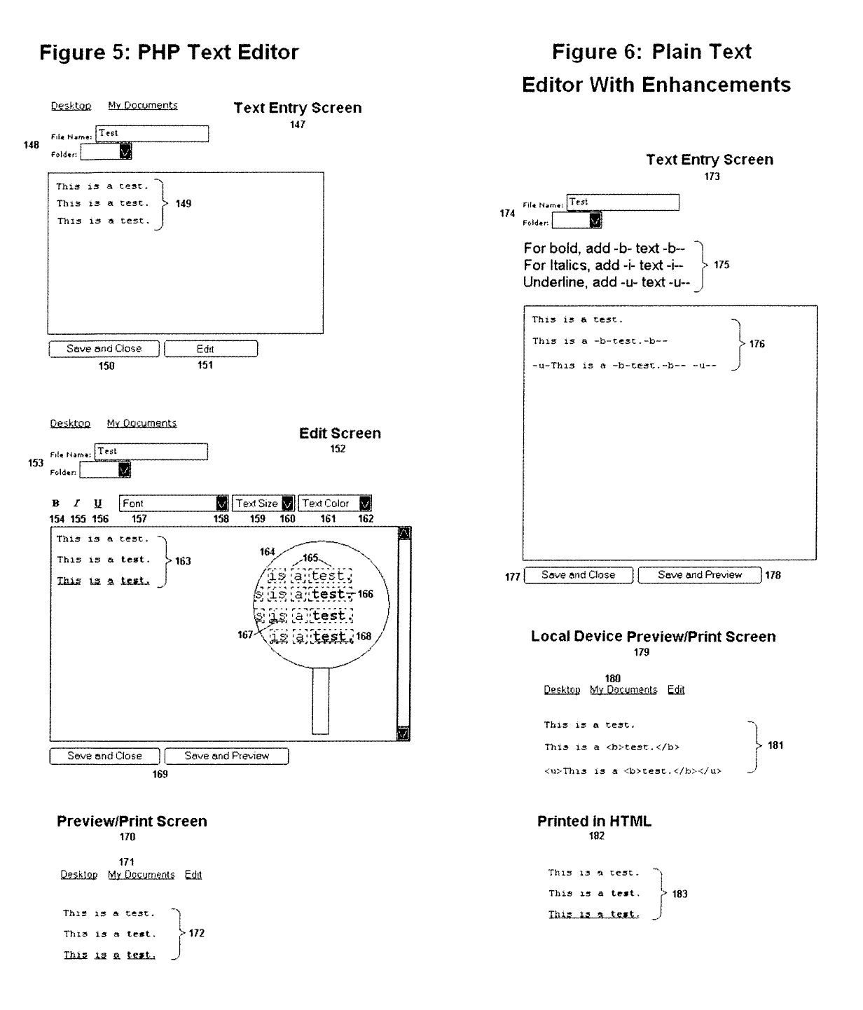

In addition to rich text features like bold, underline, italics and color, a dictionary 13 will perform spell check functions from its online database. Dictionary word lookup 14 is available from both the New Document screen and My Documents. When text has been entered and edited in text editor 12, one user option is to Save and Close 16 which will bring up the My Document screen 10 with a new saved document entry on list 17. A second option is to Save and Preview 18, serving the user an HTML view of the new or edited document which is printable and complete with rich text on Preview screen 19. If the user wants to further edit or modify the text, selecting Edit will return the document to Text Editor 12; otherwise the document can be saved in My Documents as outlined above. The PHP Text Editor 12 will be described in detail below in relation to FIGS. 5 and 9-10.

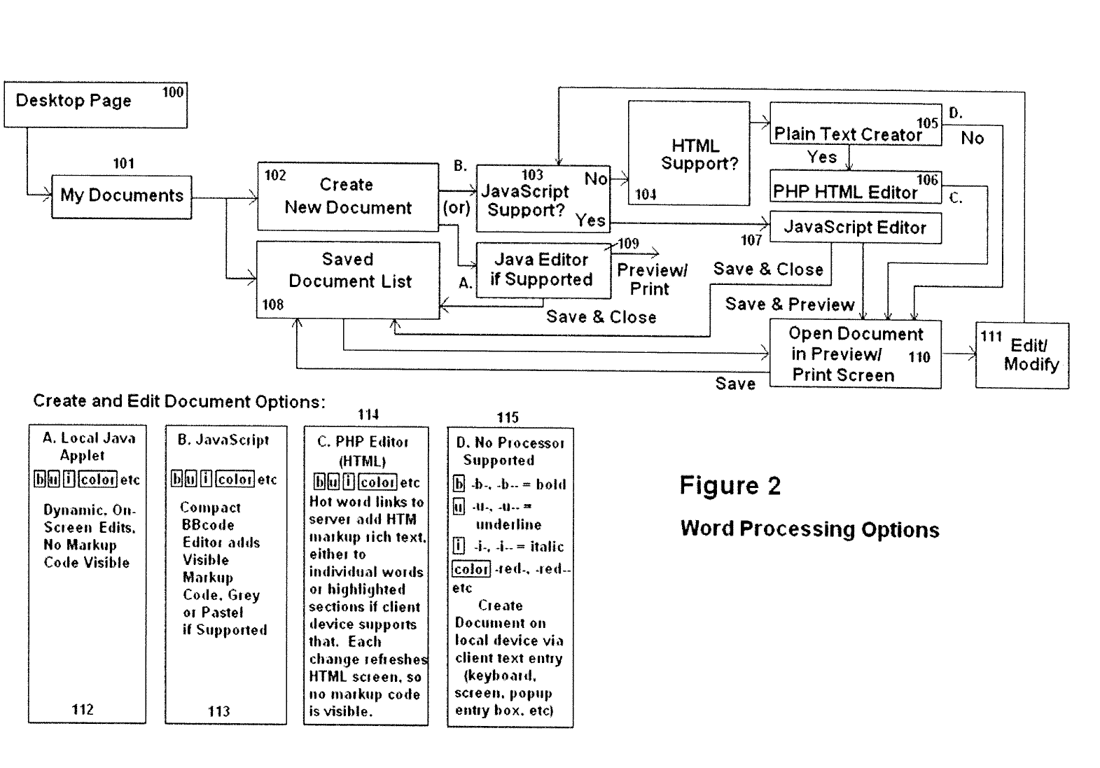

If the user selects a Saved Document 17 already stored on the web server, it will open in Preview/Print mode 19, where it can be viewed, printed or edited 20 in the manner described above. In the description under FIG. 2 to follow, various word processor options and possibilities will be explored, including novel ways to achieve rich text editing online from thin client devices.

The next function bar 30 is titled My Storage. Choosing this function will lead to a screen with an option to Upload File 31 by either browsing the computer or device for the correct file 32, or entering the file name and location manually. The My Storage screen also displays a list of files already stored 33. Clicking a stored file will download the file from the server to open, run, display, etc. For example, an MP3 or WMA file might contain a favorite song; a JPG or GIF might be a photo; or a presentation might be stored as PPT. At the discretion of the server host, individual user accounts may be given 1 GB or more storage space for their personal files.

My Storage 30 constitutes an important part of an online computer such as the one being described, since it gives virtual users a binary data vault in which to store, access and retrieve documents, presentations, music, photos or anything else they wish. My Storage can archive document templates for later pasting in the PHP Text Editor. For example, a salesperson might call up a particular product introduction template, then insert the recipient's name and any customized content, then close the new document for printing, mailing, emailing and so forth. And because it is binary in nature, My Storage is agnostic to the type of file or data being stored and retrieved, and impervious to such things as language, character set or encrypted matter that appears to all the world like garbage. This function is facilitated by a “Copy to Storage” link from the Edit screen which allows a document to be copied and saved in My Storage.

Moving down the function bars, we come to My Applications 40. Clicking here brings up an Applications List 41, currently including calendar 42, calculator 49 and clock 50. Like the majority of the functional components of CyberPC®, the calendar is coded entirely in HTML and PHP, and kept small in both screen and application size to render it compatible with cell phones and similar thin client devices. In addition to a 7-column, 6 row calendar defaulting to the current month and year and today's date highlighted, the calendar 42 screen features a “Go to” box for manual entry of a date in mm-dd-yyyy form. Inputting a date will change the calendar to that particular month and year when the “go” button is clicked.

Directly under the “Go to” box is a “Today” bar which always displays the current month, day and year regardless of where the calendar has been sent. Not only is this a useful reference, it also will return the user to the present month when clicked.

At the top of the calendar chart itself are interactive month 43 and year 44 notations surrounded by back and forward arrows, for example, <Jan> <2007>. Each click of the arrow before the month will bring up the previous month (to Dec in the example), while each click on the arrow after the month will advance it one month (to Feb). Similarly, the arrow before 2007 will turn the calendar back to January 2006, while the arrow after the year will advance it to January 2008.

Other interactive features of calendar 42 can also be provided. For example, clicking any day can bring up a Day Note creator 45 for that day, modeled after the document creator in My Documents, but with a database and file area of its own. Once the Day Note is completed and saved with reminders, appointments or whatever information, the day effected turns red. Clicking any red date 46 will bring up the note created for that particular day.

Under My Applications 40 and Calendar 42, a link to the email account of a user via the Day Notes function 47 can be added, such that a daemon account sends a given day's Day Notes to the user. The user account chosen can be one on-site (e.g., user@CyberPC®.org) or another account selected by that user.

Immediately below the calendar itself is a Day Notes bar 47. Clicking this bar will bring up the entire list of day notes in storage, for review, editing or deletion.

Another application is Calculator 49. The calculator can be of any form, for example, a scientific calculator written in JavaScript® or a universal PHP calculator. The novel PHP Scientific Calculator 49 gives simple HTML devices like low-cost cell phones their first access to a full-featured scientific calculator no longer dependent on JavaScript® or any other utility or applet on the client device to function.

The final application listed is Clock 50, preferably written in PHP and appearing to client devices in HTML form. The clock has 4 sections: on top is a calendar with notation like “Fri 19 Jan. 2007.” The second bar is the time in hours, minutes and AM or PM, in large type.

A unique feature of the “static” PHP/HTML clock environment of the present disclosure is its ability to dynamically update the time by embedding a command in the HTML to refresh at regular intervals like 15, 30 or 60 seconds (the latter is presently preferred) using the code:

<meta http-equiv=“Refresh” content=“60; url=clock.php”>

where 60 is the timeout in seconds, and url is the url for the browser to go to after that time.

In point of fact, the server does not have to do anything but reflect this HTML code telling the client browser to initiate refresh at specified intervals.

Next down is a Time Zone bar which defaults to the server time zone until set by the user from a world time zone chart accessed by clicking that bar or the final City bar. Although both functions are listed together on FIG. 2 as 51, the Time Zone button lists zones first, then cities, while the City bar lists in reverse order. Once a time zone or city is selected, the clock automatically resets to that zone.

A second clock 52 and Set Time Zone or City screen 53 has been added to the clock application, and an alarm function 55 from Clock 1 50 turns a clock alarm icon red (or highlights it in some other way) on all screens. In like manner, Day Notes generate a similar alert 54 when their particular day arrives.

My Comm 60 is the page for communications functions, including email 61, Instant Message 62, Chat Room 63, and Blog 66.

Under My Comm 60, similar alerts illuminate all screens for new mail 56 and incoming instant message (IM) 57. Although IM 62 operates from a static HTML user base, to the user it appears seamless and dynamic. Both IM and Chat functions appear like a fixed screen with changing data (both incoming and outgoing).

To create this illusion, the same code is used to the greatest extent possible in both “input” and “browse” modes, with the small variation of including a text input window in “input” mode and a PHP meta command in “browse” (receive) to make it update every few seconds to continually display the latest messages. From a user view, the only thing that changes from one mode to the other is the test input screen which appears like a pop-up over the IM or chat page.

The IM function 62 features a “VIP List,” where “invite your friends” creates a custom list of those allowed to exchange messages. Clicking one of the names on the VIP List will immediately bring up the IM screen, which appears to all the world like any dynamic messaging service, with the small exception that new messages appear on the top rather than the bottom of the screen. This is because our “transparent” meta refresh function returns to page top, and the same situation applies in the case of our chat rooms.

Chat room 63 is a common place for people to meet. Actually, it is any number of rooms, each with its own set access rules. For example, two people might share a private chat room; a development team might have another; members of a church group or social club another still. These rooms can include user head shots, icons or avatars, and time stamps on incoming communications.

Chat rooms can be on one or more web locations or pages 64; they also may take the form of an account shared among two or more users 65. An extra chat room feature might be a “door” 73 to a game room to access two-person and multi-player games. Unlike the more public game room to be described under My Games below, the players in this case will be limited to those accessing some particular chat room.

Clicking Chat Rooms 63 brings up a menu with existing public and private chat rooms (the latter requiring password to access), and an option to create a new public or private chat room. After creating or choosing a room, click “Chat” to enter. If no one else is there, a blank screen will appear, with an “Input Message” button to top; if another user is already in the room, their screen name will appear in a column to the right of the message area.

Clicking “Input Message” brings up a text entry box; enter text by typing, pasting or whatever and click “Send.” The new message will appear on the top of the message area after your screen name. Any number of users with access can come together in any chat room, exiting whenever desired. When a user exits, her/his name will disappear from the list of those present the next time the PHP meta command refreshes the screen (typically 10 seconds, but can be administratively set to any amount of time).

My Blog 66 preferably includes a number of important functions. First and foremost, it can be a blog server. Next, it can be a blog creator 67, complete with blog name, skin text and other options. It can also include a link 68 to other blog sites. Each My Blog site comes with administrative access to include/exclude other's comments and set other site parameters.

The next Desktop function is My Games 70. Clicking this bar brings up a list of games 71 including, for example, checkers 74 and hangman 75. A game room 72 accessible to all users includes games for two players or more rather than single-player games in the rest of the site like solitaire or checkers against the server.

To design checkers in a static language like PHP or HTML requires several novel approaches. Each move, whether initiated by an individual or the computer must be displayed graphically by screen refreshes, one highlighting the piece to be moved, and the second showing the piece's new position on the board.

Once again it is possible to embed an HTML meta refresh command in the PHP checkers code, this time telling the client device to auto-refresh at one second intervals when it is the computer's turn to play:

<?php if (!$_SESSION[‘my_turn’] && !$_SESSION[‘game_is_over’])
{ ?>
<meta http-equiv=“Refresh” content=“1; url=checkers.php”>
<?php } ?>

During the computer's turn, the session [‘my_turn’] is false, so the server will not run this script. When the computer has finished its actual move and made sure it is unable to continue jumping, the session [‘my_turn’] will change to “true” (user turn), so the server will not refresh. Here are the processes for computer's turn:

step one—prevent any jumps by red piece

step two—if step one not needed, look for jumps

step three—if step two not possible, look for safe single space moves

step four—if no safe moves, just move whatever you can

In this manner, static PHP and HTML keep track of what the computer is supposed to do next and does it at each refresh, giving the game a dynamic feel and providing a satisfying user experience.

Like everything else on CyberPC®, a checkers board, message box and start bar are coded to fit on small display screens like those on cell phones and PDAs. Graphics and text is confined to the essential, and the served data footprint is kept to a minimum for two reasons: 1) to not overwhelm the memory and other capabilities of small client devices; and 2) to facilitate screen refresh as quickly as possible.

For game room checkers, the same rule set applies, but without a computer player. At the client end, the refresh process takes place as each player designates, then moves a piece on the board.

A novel feature of the PHP hangman of the present disclosure is the dictionary database 76 it shares with the word processor spell checker 15, part of a dictionary 13 with a lookup application 14. Compacting and sharing features like the dictionary database contributes to reduced access time and overall site efficiency.

Under My Games 70, a PHP Solitaire version 76 can be included, with the look and feel of the ever-popular Solitaire game so long associated with Windows® on personal computers. Like the PHP Checkers game described earlier, the PHP Solitaire is totally compatible with HTML-only devices, operating completely online. To turn or move a card, click it and then click its intended destination. Both versions of the game move smoothly, adding one more element associated with the PC to mobile and thin client devices.

An additional innovation gives users the option to speed things up at the end. Once all cards have been dealt and appear face up in the columns below the game row, a “Click to Finish” option appears that allows the user to bypass the sometimes long routine of clicking each card in turn to “drag” it from a column to its place on the upper row. Click to Finish, and all the Kings appear on the finish line, in the order the user selected.

Although the current games of Checkers, Hangman and Solitaire all come with fixed graphic screens, alternatively proportional graphics can be used.

Game Room 72 is actually many game rooms. In one instance, it is a public portal off of My Games 70, where 2 or more players can sign up for a game of 2-player checkers 78 or other multi-player or head-to-head games like Scrabble (or pseudo Scrabble), dominos, chess or whatever. Game Room 72 is also any number of private game portals, each appearing as an option from an in-use Chat Room 73.

The final Desktop function is My Preferences 80. This page includes General Preferences, with modifiable boxes for User Name 81, User Email 82, Wallpaper 83 and Shortcut Style 85. Below this is some Shortcut information 87, Create New Shortcut 89 and Save Changes 91.

Clicking Wallpaper 83, for example, brings up a screen 84 with user-selectable options for grey, blue, pink, and gold CyberPC® wallpaper, or none at all (for text-only or very thin client devices). Clicking Shortcut Style 85 calls up a box 86 allowing selection of either Image (e.g., bar or icon), or text.

Shortcut information 88 is found under Shortcuts on the My Preference page. Information includes shortcut Position (1-10 below default desktop functions), Icon Text (manually entered by user), Icon style (present choices are Black-Red, Black-Blue, Grey-Red, Grey-Blue) and URL (user-entered), with a delete function below.

Choosing Create New Shortcut 89 brings up a Create Shortcut page with URL, Icon choice, Icon Text and Position boxes and a Create button. When the user selects one or more preferences, they are saved by clicking Save Changes 91, at which time the screen refreshes with the new preferences.

FIG. 2. FIGS. 2-6 show several embodiments of the word processor user options and interfaces. Selecting My Documents 101 from Desktop 100 leads in all cases to a screen including Create New Document 102 and a list 108 of saved documents. When the create document option 102 is selected, the server checks whether JavaScript® 103 or any Java® version is supported by the client device.

There are four options available for document creation with richer or lesser word processing capability:

A. If the local device supports Java®, a Java®-based editor 109 is invoked via a Java® applet as shown in box 112. This is a full word processor capable of adding bold (b), underline (u), italics (I), color, font selection and so forth dynamically for on-screen edits with no markup code visible. For example, to bold the word “test” in the sentence, “This is a test,” one need only highlight “test” and click the “b” button: immediately “test” will appear in bold:

This is a test.

To underline the sentence, just highlight and click the “u” button:

This is a test.

B. The server will likely have the ability to determine facts about the device, browser and operating system of each client logging in, to optimize user experience by making available custom components supported. For example, if JavaScript® is supported 103, a JavaScript® editor like the one depicted in 113 comes into play. Such a JavaScript® processor has been featured on the CyberPC® web site and can be used as an optional user solution. It preferably features a customized BBcode (derived from Bulletin Board) editor which adds visible markup code in edit mode to complete word processor operations like those described in A. above. Here are two examples, using the same text, “This is a test.”

To bold the word “test,” one can highlight that word and click the “b” button if highlighting is permitted by the client. If the local device cannot highlight, one can click the “b” button just before and just after the word “test.” In either case, the result will be the following on the edit screen: “This is a [b] test. [/b]. Note that clicking “b” without highlighting causes it to toggle between [b] and [/b] (start and end bold) functions.

To underline the entire sentence one can either highlight the phrase and click the “u” button or place the cursor just before “This” and click “u,” then click “u” again just after “test.” With both bold and underline added, the edited text will look like this:

[u]This is a [b]test[/b][/u]

(This edited text was copied online from the JavaScript® BBcode editor on the CyberPC® server)

When the document has been edited it is saved, either by Save and Close or Save and Preview bars below the edit screen. The latter opens the document in a Preview/Print screen 100:

This is a test.

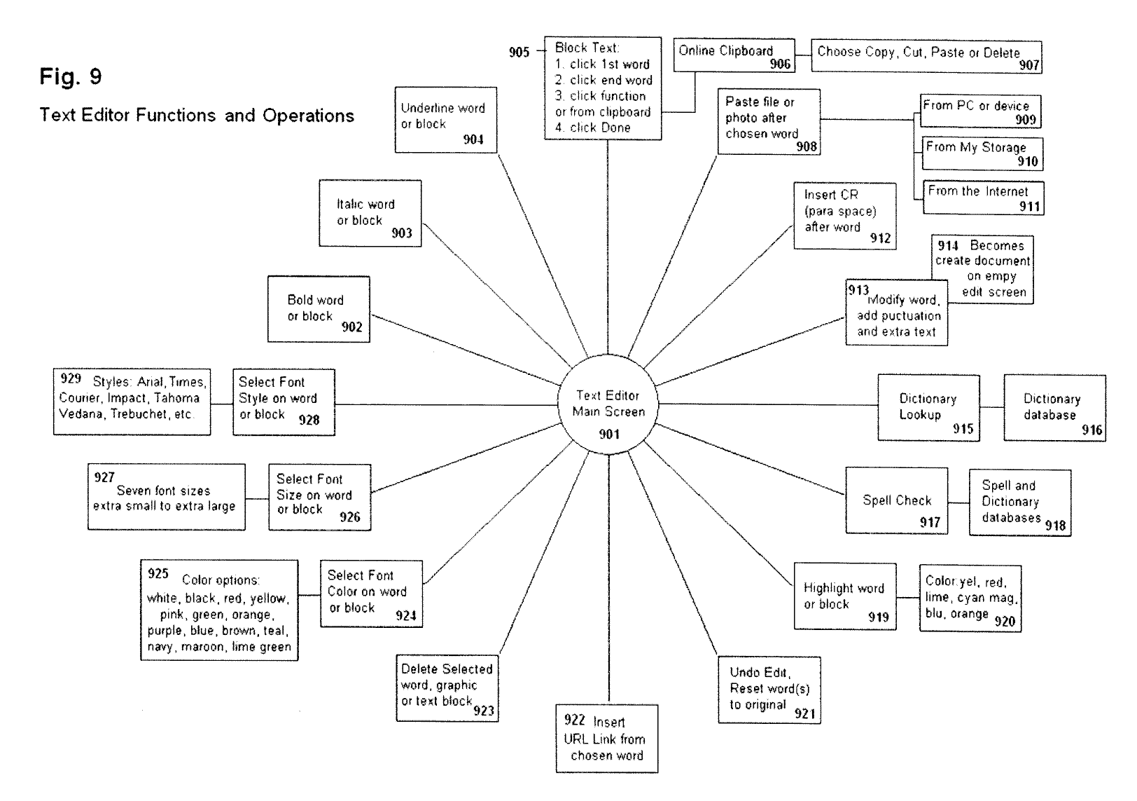

C. If neither Java® nor JavaScript® is supported but the device can display HTML 104 (most current cell phones have HTML support), the PHP Editor 106 detailed in 114 and greatly expanded in FIG. 9 can be used, which has a number of novel features. PHP Editor 106 starts with a plain text entry screen like the one in 105, where the user enters her/his message in simple text:

This is a test.

On the bottom of the screen is another bar, PHP Editor which opens PHP Editor 106. This screen renders HTML like the Preview/Print screen 110, but with two important differences:

1) Each word (defined as text between spaces) is now a “hot link” back to a processor in the CyberPC® server; and

2) PHP Editor 106 features text edit buttons like the processors above.

To bold “test,” in this case, click “b” and “test.” This sends “b” and “test” back to the server, which performs the bold operation and refreshes the copy:

This is a test.

To underline the entire sentence, choose “u” and click on each word, which will process independently:

This is a test. This is a test. This is a test. This is a test.

Since editing operations are performed word-by-word, the process is slower for multi-word operations. But there is no markup code visible, and the result is an almost universal word processor for even thin client devices like low-end cell phones. In fact, some users with JavaScript® may prefer PHP Editor 114 to the JavaScript® editor 113 that adds visible markup language before viewing in HTML.

D. If the thin client device is plain text only (increasingly rare these days), basic text is created in Plain Text Creator 105. There are novel methods D, however, to add features like those described above (bold, underline, italics, color and so forth) described in box 115. To add bold to “test” using the same sentence as an example, we could enter <b> just before and </b> immediately after the word test:

This is a <b> test. </b>

Although the local device may have no way to see the effects of that HTML code, the saved copy on Preview/Print screen 110 will print and view correctly on HTML-supporting devices:

This is a test.

Similarly, if <u> and </u> are inserted before and after the sentence, the edit screen will display as follows:

<u> This is a <b> test.</b></u>

This will display correctly on HTML devices and printers:

This is a test.

Of course, manually entering HTML code is difficult and time-consuming, and symbols like < > may be difficult or impossible to find on such thin client devices. A novel approach of the present disclosure responds to this challenge by allowing the user to enter the simpler -b- test -b--, which is translated at the server to <b> test </b>

We can do this for every HTML code operation by the user, who can place -u- before and -u--after the above sentence to yield correct HTML markup code in the server:

<u>This is a <b>test.</b></u>

Here again, this will display correctly on devices that support HTML:

This is a test.

Adding rich text capability to even plain text input is novel and useful, and better still if the initial text entry screen has a user instruction set similar to this (which may include more operations than the three below):

For bold, enter -b- before and -b--after the word or phrase.

For underline, enter -u- before and -u--after the word or phrase.

For italics, enter -i- before and -i--after the word or phrase.

When any and all of the above processor options are finished with their respective tasks, the document is either opened in Preview/Print screen 110 or saved and closed, placing the new file in Saved Document List 108 on the first My Documents page 101. Listed documents open directly in the Preview/Print screen 110, where they can be further edited and modified by selecting Edit, which once again determines device capability and serves the appropriate or selected text editor.

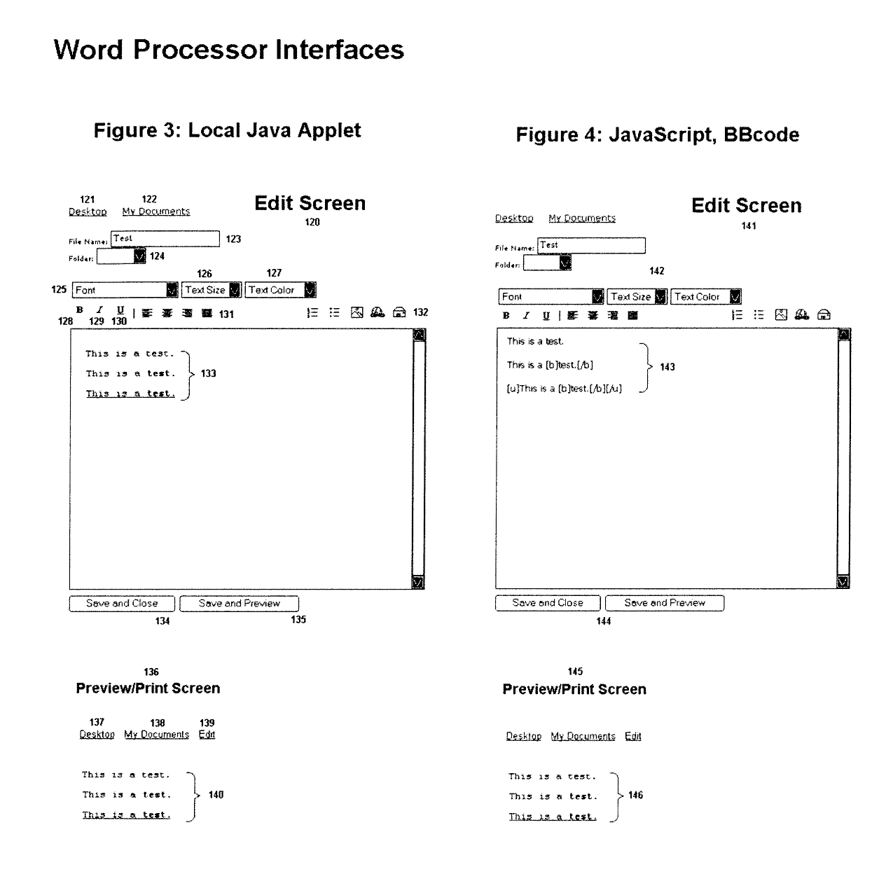

FIGS. 3-6 describe processors A-D in FIG. 2 above from the standpoint of user operability, including text entry, preview/print and edit screens, and a printed result in the case of Plain Text Processor D.

FIG. 3 depicts a Java®-based word processor that can run from an applet in cell phones and other devices with some type of Java® support. Because this is the first of the four processor interfaces, its various features will be described more completely, commencing with edit screen 120.

At the top of the edit screen are return links to Desktop 121 and My Documents 122. Immediately under these are text boxes for File Name 123 and Folder 124, the latter if desired. If the user does not enter a file name, the document created will be saved as “untitled.”

Now we come to a set of typical text-enhancing features, including font 125, text size 126 and color 127. Clicking the down arrow (V) at the end of each of these boxes will bring up a selection list. Font, for example, might include Arial, Courier, Impact, Tahoma, Times New Roman and Verdana. Text sizes might include XX Small, X Small, Small, Medium, Large, X Large and XX Large. And the color list could have Black, Red, Yellow, Green, Orange, Purple, Blue, Brown, Teal, Navy, Maroon, Lime Green and White. The font, text sizes, and color lists provided are merely exemplary and the lists of potential options are not limited to the examples provided.

White can be used in a novel way to designate fixed spaces. For example, text might be aligned in a certain way by the inclusion of dots, for indent and offset purposes, among others:

1. This is a test.

.....A. This is a test.

...........i. This is a test.

In a text entry system supporting color but not tabs, turning the spacer dots white renders them invisible while maintaining precise layout alignment:

1. This is a test.
A. This is a test.
   i. This is a test.

White comes in especially handy to make graphics, charts and grids align correctly on small devices, many of which have a tendency to automatically eliminate as much blank space as possible. So, for example, if a user desires that the calendar sit a little bit out from dead left on the screen, the user can include dots or other characters to achieve the offset. These spacers will remain invisible to the user as long as they are white or match the background color on wallpaper or internal areas such as the dates on the calendar.

Shown directly under the font selection bar 125 are buttons for Bold (B) 128, Italics (I) 129 and Underline (U) 130. Highlighting a word, sentence or section then clicking on any button or pull-down 125-130 will modify that text according to the action desired.

The next four icons 131 control the format of selected sections: align left, center, align right, and justify. The next five icons 132 insert numbered list, insert bulleted list, insert image, insert hyperlink and insert email address. Of course there are many other action buttons, including slash (to cross out text edited out), insert quoted text, insert code, and so forth, but those included here will serve to illustrate.

The text insertion area simply replicates a blank sheet of paper onto which the user creates a document: by keyboard, touch screen, graffiti, copy and paste or some other text entry means. Shown as 133 are the three examples of the phrase, “This is a test” described in FIG. 2 above. In a dynamic word processor like that of FIG. 3, text can be entered, then highlighted to add bold or underline, or the proper functions can be selected during text entry. In either case, the result will preferably display immediately on the device screen, in exactly the manner of virtually all computer word processors.

When document creation is complete, the user selects either Save and Close 134 or Save and Preview 135. The former adds the new document to those listed in My Documents; the latter Print/Preview Screen 136 is shown at the bottom of FIG. 3, with the text in HTML for printing or viewing 140, and return paths to Desktop 137, My Documents 138 and Edit 139. (These links preferably are not shown in print.)

FIG. 4 depicts an editor created from PHP and JavaScript® and currently a customizable option on CyberPC®, with Edit Screen 141 generally having the same feature set 142 as the Java®-based editor in FIG. 3 (121-132). The difference is that this processor is not able to dynamically add bold, underline and other features on the fly, but rather inserts a variation of HTML markup code called BBcode 143.

Below are the same save options 144 and a Print/Preview Screen 145 indistinguishable from those of FIG. 3 once the coded text is viewed in HTML 146.

FIG. 5 shows a PHP Text Editor with dynamic rich text capability. Processing commences with Text Entry Screen 147, featuring links, file name and folder input areas 148 like those in previously-described processors. However, Text Entry Screen 147 in this editor consists of a plain text entry box without editing ability. One major advantage of this process is the ability to accommodate the pop-up text entry systems found in so many cell phones and other small devices.

The text entered in this case would simply be “This is a test” three times with nothing added or marked 149. At the bottom of this screen are Save and Close 150 and Edit 151 bars rather than the Save and Preview of other processors.

Selecting Edit 151 brings up Edit Screen 152 with the usual links and name boxes 153. An on-screen editor is also here, with at least the following options: Bold 154, Italics 155, Underline 156, Font 157, Text Size 159 and Text Color 161.

The screen starts with the same three “This is a test” messages in plain text that were put there in 149 above, but this is a different, HTML screen in which each word or text area between spaces has been made interactive (into a “hot-link”) by the server. Magnified portion 164 shows dotted lines around each word for clarity.

The second “This is a test” line is the one in which we wish to bold the word “test.” This we can do by first clicking on “test” in 165 communicating this information to the server which then returns “test” highlighted or distinguished in a manner similar to what happens when we click on a piece that will be played in the checkers game described under FIG. 1.

With the word “test” highlighted, we now click the action we wish to perform: the B button in this case to make it bold. The click will be communicated to the server, which then returns the bold test 166. In the next case, we wish to underline the entire sentence. This is done by selecting each word in turn, then clicking U to underline that word. In magnified view 167, we have underlined the first two words; in 168 all four are underlined. Note that the result shows each word underlined, but not the space between them.

As with the other processors described herein, Save and Close or Save and Preview options 169 lead to the file list in My Documents or to Preview/Print Screen 170, respectively. The latter is depicted in 172. This novel PHP Text Editor, significantly expanded in FIG. 9, has the feel of processors usually residing on a computer, and offers a number of unique features, including:

1. Compatibility with a vast number of cell phones, PDAs, game consoles, web browsers and low-end computers, even those without Java® and JavaScript® support.

2. Dynamic editing on the fly.

3. No visible markup code, HTML, BBcode or other.

4. Adds rich text features like bold, underline, font selection, text size and color to devices never before having such capability.

5. Two-stage enter-edit process accommodates any type of initial text input, including pop-up text box.

FIG. 6 is a Plain Text Editor for universal compatibility, complete with enhancements allowing users to enter simple markup code for the creation of rich text, even on devices without HTML support. Text Entry Screen 173 includes the usual File and Folder name boxes 174, and text entry exactly like that just described under FIG. 5 above.

But unlike the PHP Editor in FIG. 5, users can enter simple code immediately before and after text they wish to make bold, italicize or underline, per the instruction set 175 immediately above the text entry screen or pop-up box:

For bold, add -b- text -b--

For italics, add -i- text -i--

Underline, add -u- text -u--

This novel approach renders manual editing extremely simple, using characters universally available to cell phone and other thin client device users. This is done by means of a translator at the server end that changes the bold code above to standard HTML <b> text </b> and does the same for italic, underline and other markup code.

The text strings 176 show how the user would bring our rich text examples to the test sentences, which are then saved and closed 177 or saved and previewed 178 on the local device preview screen 179. For plain text-only devices without HTML support, the preview screen will show markup code that has been translated to HTML 181.

If this text is printed 182 or transferred to a device supporting HTML, the result will be the three sentences shown in 183, which are indistinguishable from printing the same material composed by the processors of FIG. 3 or 4.

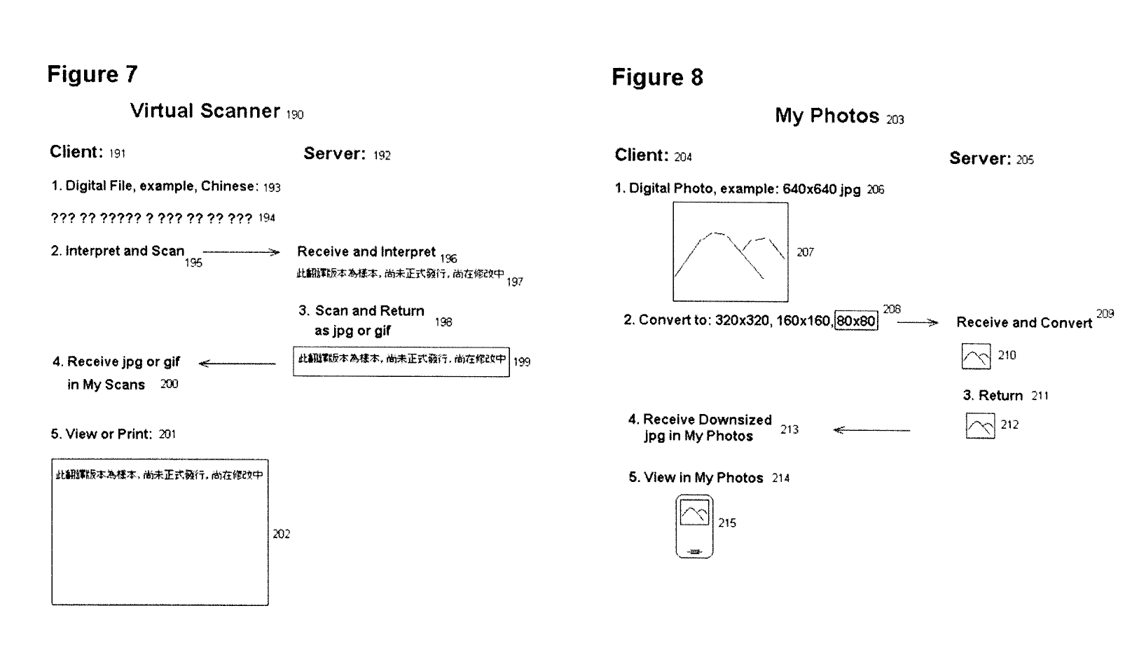

FIG. 7 delineates a Virtual Scanner function 190 which can be used to interpret language characters not supported by the client device. This feature is useful alike for OnePlanet® PC's multi-cultural, multi-lingual client base; for CyberPC®'s many smart phones, game consoles and web browsers, and for Virtual SmartPhone™'s low-end cell phone users.

In the drawing, Client-side functions 191 are to the left, while Server-side operations 192 are to the right. Consider, for example, a digital file that has come to the user in Chinese 193, by email, chat room, download or other means known in the art. In a client device not supporting Chinese, the text would appear unreadable 194.

In this case, the user can place the unreadable document into an Interpret and Scan folder or other environment 195 which would send it to a Receive and Interpret 196 operation in server 192. This area of the server would support multiple languages and formats, quickly rendering the incoming digital file into Chinese 197.

The resulting Chinese document would then be converted to a format like .JPG or .GIF. The resulting “Virtual Scan” 199 is then returned to the client device, where it can be saved in a “My Scans” folder or category 200.

When the converted file is called up to View or Print 201, it will display in Chinese or any other character or symbol set, even on devices not normally supporting that language 202.

FIG. 8 illustrates another server-side function, that of reducing photos and graphics to minimize storage while maintaining quality sufficient for small displays. My Photos 203 may be included as a new function on the desktop, incorporating both Client 204 and Server 205 operations.

In the example 206, a 640 by 640 pixel digital photo 207 has been loaded onto the client device. A “Convert to:” menu 208 gives the user options to downsize the photo to 320×320, 160×160 or 80×80 pixels, the latter shown as the one chosen to send to the server. Other pixel ranges can be used as desired.

A Receive and Convert server 209 operation performs an 80 by 80 pixel rendering 210 of the original photo, which is then returned 211 to the client device where it is received as a downsized JPG in My Photos. The resulting photo can still be viewed satisfactorily 214 on the client device's small screen 215. At this point the original, large data photo can be deleted, leaving room for many favorite photos and graphics.

While the examples in FIGS. 7 and 8 deal with language characters and photos, the concept can be utilized for many other enhancements to the user experience, including the reformatting of other files to fit user needs and device standards. Some possibilities include audio, video and audio-visual files, slide shows, podcasts and the like.

For example, the client device may support JPG but not TIFF standards. In such a case, a menu might allow that user to: 1) identify the format of the unsupported TIFF file; and 2) utilize the online application to convert from TIFF to JPG.

The online converter could also provide methods and means for the expansion and reconstruction of various compression formats like ZIP and RAR, making the resulting opened contents selectively available to the user and client device.

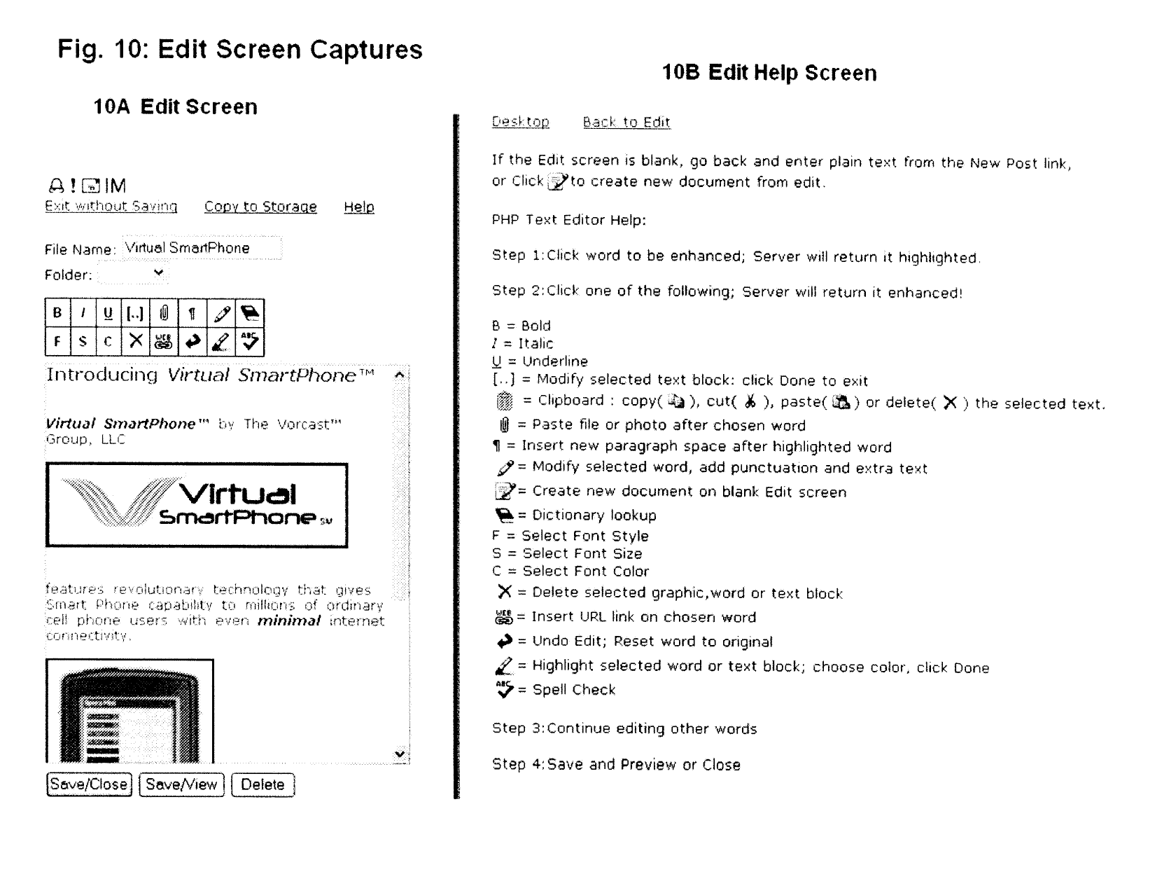

FIGS. 9 and 10 relate to the presently preferred PHP-driven, HTML Text Editor which can occupy block 12 on FIG. 1 above. FIG. 9 represents the functions and operations of the Text Editor in block form, while FIGS. 10A and B are screen captures of its Edit page and Edit Help screen, respectively.

After raw text is entered on the blank screen in New Document, it can either be saved in that form or edited by clicking the Edit link on that page. When Edit is clicked, each word in raw text is made into a “hot” independent link in Edit mode. This novel concept is accomplished by the following PHP and HTML code:

1. Separate each word

$newdoccontents =
html_entity_decode($_POST[“txtDocument”]).“&nbsp;”;
$newdoccontents = str_replace(“ ”,“&nbsp;”,$newdoccontents);
$chars = explode(“&nbsp;”, $newdoccotents, −1 );
$_SESSION[“count”] = count($chars);
for ($i=0;$i<$_SESSION[“count”];$i++)
{
$_SESSION[$i.“word”] = $chars[$i].“&nbsp;”;
}

2. Show each word

for ($i=0;$i<$_SESSION[“count”];$i++)
{
<a class=“link” href=“phpeditor.php?<?
echo htmlspecialchars(SID); ?>&word=<? echo $i;
?>&edit=<? echo $edit; ?>”>
<? echo $_SESSION[$i.“word”]; ?>
</a>
}

FIG. 9 depicts functions and operations of the Text Editor. The inner blocks around Text Editor Main Screen 901 correspond exactly to a clockwise tour of the function keys on the actual screen capture of FIG. 10A, starting with the “Bold word or block” box 902 on FIG. 9 and the “B” key on FIG. 10A, and ending with the “Select Font Style on word or block” box 928 on FIG. 9 and the “F” key on FIG. 10A. Each of these function keys is further defined on the Edit Help Screen, captured as FIG. 10B.

In FIG. 9, the center circle 901 represents the Edit screen that appears in the My Documents application by clicking “Edit” from either an existing or new document page. The screen is shown as it appears on a computer, thin client or mobile device in FIG. 10A. As explained previously, text is first entered on the blank screen of a New Document window, where our “This is a test.” message appears like this, both in raw (View Code) and finished form:

This a test.

But in the Edit screen each word is a link. So one can click on “test,” then click on the “B” key (Bold word or block 902 on FIG. 9), and instantly see the result on the Edit screen, which returns WYSIWYG (what you see is what you get) HTML code with every click operation:

This is a test.

If I save and view this file, it will appear exactly the same:

This is a test.

On the other hand, the “View Code” option on the open document screen will now display not only visible text but all the markup code as well:

This is a <b>test.</b>

The same situation applies if we click on “This” and then click the Italic function 903. On Edit and View screens:

This is a test.

Similarly, clicking “is” and Underline function 904 will return:

This is a test.

The previous examples all involved individual words. Another innovation in the present disclosure is Block Text function 905, whose four steps are outlined in the box in FIG. 9:
1. Click the first word of the text to block.
2. Click the end word of the text to block.
3. Click the function key for the desired operation, or the Clipboard function (described below).
4. Click Done

Whatever the user wished to do with the block of text will now be accomplished and visible. For example, blocking “This is a test.” then choosing the Bold function 902 will return this result:

This is a test.

But View Code will look like this

<b>This</b> <b>is</b> <b>a</b> <b>test.</b>

where <b> means “start bold” and </b> means “end bold” in HTML code.

Normally, bolding “This is a test.” would entail the addition of <b> before “This” and </b> after “test.”:

<b>This is a test.</b>

While this appears simpler, it does not allow further edits without errors. For example, deleting “test” under this strategy would yield the following (because the “word” removed is the connected “test.</b>”:

<b>This is a

Unfortunately, that operation would have the undesired effect of bolding any other text to follow, while removing “test” the way we actually do things would yield:

<b>This</b> <b>is </b> <b>a</b>

This leaves each word “island” properly in bold text and ends the bold process with the final “a.”

Online Clipboard 906 provides clipboard functionality to the millions of low cost mobile phones and thin client devices with no or limited clipboard capability. The clipboard can be an adjunct to the Block Text function 905, with that [ . . . ] icon changing to a clipboard whenever text has been blocked. But it can just as well appear on a function key of its own, allowing clipboard operations like Copy, Cut, Paste and Delete 907 to apply to individual words as well as blocks of text. Putting full clipboard ability online gives tremendous processing power to otherwise thin and weak devices, especially when coupled with all the other novel features of the PHP Text Editor.

Paste function 908 is similarly useful, inserting pastes of files or photos immediately after any word. When paste is chosen, a menu screen allows pasting from the local device 909, My Storage 910 or from an Internet source 911.

The paragraph marker key corresponds to Insert CR Space operation 912. Choosing this function twice after a chosen word will start a new paragraph two spaces down as in the current text.

Clicking Modify Word 913 puts the chosen word in a “pop-up” text box (as in other operations, the text box only appears to pop up; in reality it is framed in a new screen where everything else remains the same). The selected word can be altered or deleted, punctuation can be added or changed, and additional text can be placed before or after the word. Choosing, for example, the “a” in “This is a test,” that “a” will appear in the text box for alteration: a (delete, then add) one really big. Click OK and the modified sentence will read: This is one really big test.

If Edit is entered with a blank screen, Modify 913 changes to Create Document 914 and the corresponding icons change from a simple pencil in the first case to a document and pencil in the latter. The function itself is the same, a text box to add text to an otherwise empty “sheet.”

Multiple edits can produce very rich text (words 1-3 and 5 are blue, while “test” is red, “PHP Editor” is large and italicized):

This is a test of the PHP Editor new build.

View Code for the same sentence appears like this:
<font color=blue>This</font> <font color=blue>is </font> <font color=blue>a</font> <font color=red><b>test</b></font> <font color=blue>of</font> the <i><b><font size=4>PHP</font></b></i> <i><b><font size=4>Editor</font></b></i> new build.

Dictionary Lookup 915 checks the selected word against an online dictionary. Once a user accesses the dictionary, additional words and definitions can be looked up in a dictionary database 916 created just for this application.

Spell Check 917 checks the spelling of any chosen word. Spell Check Database 918 may reside in the PHP library or come from online Dictionary 915.

Highlight function 919 will highlight a selected word or text block in one of a number of colors, including those delineated in box 920.

Undo function 921 will undo all edit operations and reset a selected word or text block to its original state, regardless of when any editing took place.

Insert URL 922 will link the chosen word or block to a site on the Internet selected by the user.

Delete 923 deletes whatever is selected, but this is a true delete and not a cut function involving the clipboard.

Font Color 924 “pops up” a color chart with selections like those in box 925, to apply to either individual words or blocks of text.

Font Size 926 similarly allows font selection from extra small to extra large from a “pop-up” selection box 927.

Font Style 928 is exactly like the previous functions, except that the “pop-up” choices involve various font styles like those in box 929.

Additional features can be added to the embodiments of the systems disclosed herein. For example, a My World 100 (FIG. 1) portal for live (streaming) services like news, weather, sports, stock and financial reports can be added. Two classes of such services are envisioned. One On-Server group 101 will reside on or at least be served by the online computer host server. External Links 102 will come from sources outside the online server, but will pass through the My World portal in any event. My World 100 portal very preferably is subject to customization or various configurations, depending on the class of services to be offered and the type of device(s) that will receive and resolve the content of each data stream. “My World,” can be a portal for streamed content from either a host server or others, and an online repository for music, electronic books and other publications, and media including songs, ring tones, podcasts and video.

The systems and methods disclosed herein can also be used to provide customized online environments for various user groups including mobile communities like Research In Motion® and users of their popular BlackBerry® phones; media organizations like CNN®; schools and universities; business enterprises and many other models. The architecture of the present disclosure is highly scalable and customizable, lending itself readily to the new business models.

My Photos and Scans has functions described in Section Two and FIGS. 7 and 8, but many other server-side functions are possible when the HTML and link operations of an end user become “remote control” commands for some application better done on a computer with plenty of speed and memory. For example, any number of auto-forms could be served; rudimentary CAD (computer aided design) entry could take place on the thin device and be processed on the server; databases of all sorts (fingerprint, medical, wanted or missing people) could reside server-side and be queried from small mobile or portable devices in the field.

As an example that might reflect into My World, full-screen television could be received and processed on the server side, then “forwarded” to a small or relatively weak end-user device in a format and bandwidth compatible with that device and its Internet delivery limitations.

Another feature is an online repository which provides a user-invisible portal to a number of electronic libraries available by subscription, on a pay-per basis, as a premium service, or even free of charge. For example, a My Music repository might feature free MIDI files, MP3, WMA and other samples, and numerous selections available by subscription or pay-per-song or album basis.

A My Books repository has many options to ponder, including electronic libraries, free and pay-per services for books, magazines, printed news organs, legal and business forms, greeting cards, coupons and periodicals of all sorts. Since the entire architecture of the present disclosure is digital in nature, this category is essentially agnostic to language and text characteristics, making it an ideal vehicle to empower masses of people in the OnePlanet® PC model.

A My Media repository is a catch-all portal for electronic media of every sort—video and A-V clips, movies, podcasts, games, ringtones—in accordance with the needs of a particular user group and the devices they employ.

A versatile online word processor compatible with Internet-capable cell phones, game consoles, smart phones, PDAs and web browser devices as well as Internet-ready computers of almost any age or configuration is the bedrock of a successful online computer. Great care must be taken, therefore, to make such an offering as universal and thin client-tolerant as possible.

Many things can be done to assure universality in an online computer. For one thing, a minimalist approach is necessary across the web site. An example of this approach is the use of icons or bars with low Byte content that can just as easily display as labels on text-disabled clients.

Wallpaper can be made from a simple, repe graphic, typically in JPG form to be viewed on as many browsers as possible. Unlike the elaborate background graphics on other web sites, cyberpc.org for example, utilizes less than 2.4 Kbytes for its wallpaper, 10% or less of most sites tested.

Icons or graphic bars on the CyberPC® site average about 260 bytes each, compared with about ten times that amount on other web sites. Underlying code is carefully constructed throughout for maximum functionality from the smallest possible downloads.

As reported above, style sheets like CSS may display badly on cell phones and other “bare bones” devices and browsers. Applying the systems and methods described herein, PHP or similar form queries are used to detect these thin clients and serve them a scaled-back or customizable view. In the latter event, people using small devices may prefer text-only display.

Many cell phones, for example, do not come with an Internet plan and are billed a certain amount per KB. Giving them the option to turn off images, or disabling images altogether for the WAP browsers, could save them a lot of money. Since many small Internet-ready devices have little space for large or elaborate processes, it may be possible to serve such processes in segments as needed, allowing very thin clients to play games or process documents on the fly. Moreover, small client devices like cell phones have very limited screen real estate. As a consequence, each web page must be kept small and compact enough to be easily visible and accessible to such devices, particularly in the CyberPC® user universe.

Throughout the web site, care must be taken to avoid functions and languages with limited distribution or client support. Examples include Java®, Flash, and Perl®. While JavaScript® tends to be considered a universal language, even it is not universally supported, particularly in heavy doses. For that reason where JavaScript® is necessary, it is kept compact or broken into smaller components to the extent possible.

The various embodiments disclosed herein are susceptible to various modifications and alternative forms, and specific examples thereof have been shown by way of example in the drawings and are herein described in detail. It should be understood, however, that the various embodiments disclosed herein are not to be limited to the particular forms or methods disclosed, but to the contrary, the invention is to cover all modifications, equivalents, and alternatives falling within the spirit and scope of the claims.

I claim:

1. A web-based computer system for a client device comprising:
a word processor, wherein the word processor comprises a text editor and is adapted to provide a writing template that resides on the client device; and
storage for the retention of a first plurality of files;
wherein the system is written for a client device comprising a thin client device and the system is written in HTML, PHP or both.

2. The system of claim 1, wherein the writing template is a PHP form.

3. The system of claim 1, wherein the writing template is an HTML form.

4. The system of claim 1, wherein the client device is an Internet-capable device, mobile phone or small screen device.

5. The system of claim 1, wherein the text editor comprises a PHP text editor that allows for formatting of text without user entry of markup code, HTML or BBcode.

6. The system of claim 5, wherein PHP text editor is configured to create a link to a processor on a server for each word to be formatted.

7. The system of claim 6, wherein the word is formatted by selection of a formatting action when the link is activated.

8. The system of claim 1, wherein the text editor comprises a PHP text editor that allows for formatting of text without use of programming script written in JavaScript®, Java®, Flash, or AJAX script.

9. The system of claim 1, wherein the text editor comprises a plain text editor that can be used to create rich text on devices lacking HTML support.

10. The system of claim 1, further comprising an online converter adapted to convert a first file that cannot be resolved on the user device into a compatible format.

11. The system of claim 10, wherein the first file comprises a photograph, audio file, video file, or compressed file.

12. The system of claim 10, wherein the first file comprises text with language characters that are not supported by the user device.

13. The system of claim 1, further comprising an online repository for the storage of a second plurality of files.

14. The system of claim 13, wherein the second plurality of files include one or more of photographs, music files, or video clips.

15. The system of claim 1, further comprising one or more games.

16. The system of claim 15, wherein the games include one or more of solitaire, checkers and hangman.

17. The system of claim 15, wherein the one or more games are written in PHP and are dynamically refreshed at specified intervals.

18. The system of claim 1, further comprising a login page.

19. The system of claim 1, further comprising a server, the server configured to store changes to the writing template.

20. The system of claim 1, further comprising a clipboard tool, the clipboard tool being configured to allow for editing functions including one or more of copying, pasting, cutting, deleting, and highlighting.

21. The system of claim 1, further comprising a clock, wherein the clock is written in PHP and is dynamically refreshed at specified intervals.

22. The system of claim 1, further comprising a communications application configured to support one or more of email, instant messaging, chat rooms, and blogs.

23. The system of claim 22, wherein the communications applications is written in PHP and is dynamically refreshed at specified intervals.

24. A method of formatting text on a user device comprising:
displaying the text to be edited in plain text or HTML, wherein the text comprises one or more words;
creating a first link for a first word, wherein the first link is a connection with a processor on a server; and
formatting the first word based on a selected formatting option,
wherein the user device is a thin client device.

25. The method of claim 24, wherein the selected formatting option is selected from the group including bolding, underlining, and italicizing.

26. The method of claim 24, wherein the selected formatting option is selected from the group including copying, pasting, cutting, and deleting.

27. The method of claim 24, wherein the user device is Internet-capable device, mobile phone or small screen device.

28. The method of claim 24, further comprising pasting a file after a selected word.

29. A method of formatting text on a user device comprising:
displaying the text to be edited in plain text or HTML, wherein the text comprises one or more words;
creating a first link for a first set of words, wherein the first link is a connection with a processor on a server; and
formatting the first set of words based on a selected formatting option,
wherein the user device is a thin client device.

30. The method of claim 29, wherein the selected formatting option is selected from the group including copying, pasting, cutting, and deleting.

31. The method of claim 29, wherein the selected formatting option is selected from the group including bolding, underlining, and italicizing.
